(19) United States
(12) Patent Application Publication
(10) Pub. No.: US 2025/0029013 A1
(43) Pub. Date: Jan. 23, 2025

(54) Universal Post-Training Backdoor Detection and Mitigation for Classifiers

(71) Applicant: Anomalee Inc., State College, PA (US)

(72) Inventors: David Jonathan Miller, State College, PA (US); George Kesidis, State College, PA (US); Hang Wang, State College, PA (US)

(73) Assignee: Anomalee Inc., State College, PA (US)

(21) Appl. No.: 18/909,902

(22) Filed: Oct. 8, 2024

Related U.S. Application Data
(63) Continuation of application No. 18/485,956, filed on Oct. 12, 2023.
(60) Provisional application No. 63/415,597, filed on Oct. 12, 2022.
(60) Provisional application No. 63/422,894, filed on Nov. 4, 2022.
(60) Provisional application No. 63/462,201, filed on Apr. 26, 2023.

(51) Int. Cl. G06N 20/00

(52) U.S. Cl. CPC G06N 20/00

(57) ABSTRACT

The disclosed embodiments disclose techniques for performing universal post-training backdoor detection and mitigation for classifiers. Mitigation of overfitting for a trained classifier begins with receiving the trained classifier and a clean dataset that spans a plurality of classes for the trained classifier. A set of input patterns are used to calculate classification margins for the trained classifier, and maximum classification margins are calculated for one or more classes of the trained classifier. Overfitting can then be mitigated by reducing one or more of these calculated maximum classification margins while maintaining the accuracy of the trained classifier for the clean dataset. In some embodiments, a backdoor detector may also detect target classes for a putative backdoor in the trained classifier upon detecting that the corresponding maximum classification margins for those target classes are anomalously high compared to the maximum classification margins of other classes.

### RELATED APPLICATIONS

This application is a continuation of, and hereby claims priority under 35 U.S.C. § 120 to, U.S. Non-provisional patent application Ser. No. 18/485,956, entitled “Universal Post-Training Backdoor Detection and Mitigation for Classifiers,” by David Jonathan Miller, George Kesidis, and Hang Wang, Attorney Docket Number ANOM-009-US-NP, filed on 12 Oct. 2023, the contents of which are herein incorporated by reference in their entirety for all purposes. U.S. patent application Ser. No. 18/485,956 claims priority under 35 U.S.C. § 119(e) to: (1) U.S. Provisional Patent Application No. 63/415,597, by inventors David Jonathan Miller, George Kesidis, and Xi Li, entitled “Detection and Classification Exploiting Radial Symmetry,” filed 12 Oct. 2022 (Attorney Docket No. ANOM-006_2-US-PR); (2) U.S. Provisional Patent Application No. 63/422,894, by inventors David Jonathan Miller, George Kesidis, and Hang Wang, entitled “Ensemble-Policy Active Learning for Classification and Regression,” filed 4 Nov. 2022 (Attorney Docket No. ANOM-008-US-PR); and (3) U.S. Provisional Patent Application No. 63/462,201, by inventors David Jonathan Miller, George Kesidis, and Hang Wang, entitled “Backdoor-Agnostic Post-Training Backdoor Mitigation for Deep Neural Network Classifiers,” filed 26 Apr. 2023 (Attorney Docket No. ANOM-009-US-PR). The contents of all of the above-referenced applications are hereby incorporated by reference.

### GOVERNMENT LICENSE RIGHTS

This invention was made with Government support under Grant No. 2132294, awarded by the National Science Foundation to Anomalee, Inc. The government has certain rights in the invention.

### BACKGROUND

### Field of the Invention

The invention pertains to secure and robust deep learning. The invention provides a principled, practical, and effective way to detect and mitigate malicious backdoor data-poisoning (security) or natural backdoors or biases (robustness) in DNN classifiers. As such, this invention is relevant to adversarial learning and also to the field of explainable (or interpretable) AI (since it is fundamental to explainable AI to ascertain whether or not the DNN is performing as intended, with backdoor-poisoned DNNs not performing as intended). More particularly, the invention is agnostic to the backdoor pattern itself and agnostic to the manner in which it is incorporated into the poisoned training samples and operational backdoor triggers. Since the invention does not assume any knowledge of the backdoor pattern and its method of incorporation, and since it aims to be effective for a wide variety of backdoor patterns and methods of incorporation, it is referred to as a universal backdoor (Trojan) detector and mitigator.

### Related Art

Machine-learning techniques facilitate building models based on sample data (e.g., “training data”) that can then be used to make predictions or decisions. Machine-learning techniques are becoming increasingly used in a wide variety of applications, such as email filtering, image and text generation, audio processing, and computer vision, in which leveraging conventional techniques to perform a given task is difficult or infeasible. Analysis performed upon the sample data determines a set of trends and/or underlying characteristics that are then used to configure and train the AI, which can then be used to make decisions for new sets of (non-training) data.

However, because such techniques leverage automated analysis and generation of models, they can be vulnerable to data poisoning. Backdoor data-poisoning attacks seek to embed backdoor patterns that are not noticeable to humans but can subtly change the outputs of the AI to suit the goals of an attacker. Such attacks, sometimes called Trojans, may leverage a huge variety of possible backdoor patterns, making the detection of backdoor data poisoning very challenging.

Hence, what is needed are techniques and systems for detecting backdoor poisoning in a machine-learned decision-maker without the problems of existing approaches.

### SUMMARY

Some embodiments of the present invention operate unsupervised, post-training (without assuming access to the training dataset) to detect and mitigate backdoor data-poisoning of machine-learned models (particularly a deep neural network or DNN) classifier and test-time (online, operational) backdoor triggers. Backdoors can be planted while the training dataset is being formed prior to the model being trained (its parameters learned) or during an online active learning or online reinforcement learning process to dynamically refine the model. Moreover, unlike many existing backdoor detectors and mitigators, some embodiments of the present invention do not make any assumptions about the backdoor pattern or its method of incorporation into training and test samples, and seek to detect and mitigate effectively irrespective of the backdoor pattern and the method of its incorporation chosen by the attacker. In this sense, embodiments of the present invention are “backdoor agnostic” or “backdoor universal,” in addition to being applicable to different models for classification or clustering (including ensembles of models). Detection of backdoor poisoning of the DNN in such embodiments does not require clean (unpoisoned) samples, while mitigation and backdoor trigger detection at test-time do leverage a small clean (correctly labelled and not maliciously modified) dataset. Some embodiments of the present invention can be applied to non-backdoor (“error generic”) poisoning of the training dataset or to non-malicious overfitting (biases) due to problems such as over-training or class imbalances in the training dataset.

For detection, some embodiments of the present invention rely on the principle that, in order to consistently classify backdoor poisoned training samples (and consequently backdoor trigger test samples) to the target class of the attack, DNN training tends to overfit to the backdoor pattern, so as to overcome the source-class discriminative features which are also present in the backdoor-poisoned training samples. The implication of such overfitting is that the maximum classification margin (decision-confidence based on the output class logits) for a backdoor target class will tend to be much larger than that for a non-target class. Thus, the present invention detects backdoors by hypothesis testing using the maximum classification margin statistics for all classes. Some embodiments of the present invention's backdoor mitigation technique leverage a clean dataset to limit the allowed internal activations of a DNN. This is consistent with a principle of security that seeks to prevent activity which is extraneous to the designed behavior of a system (here, the “normal” range of activations induced by the clean (validation) set). Some embodiments of the present invention jointly operate both the unmodified and the backdoor-mitigated DNNs to detect operational backdoors when their class decisions differ, particularly when the unmodified DNN classifies to the detected target class.

In some embodiments of mitigating overfitting for a trained classifier, operation begins with receiving a trained classifier and a clean dataset that spans a plurality of classes for the trained classifier. A set of input patterns are used to calculate classification margins for the trained classifier, and maximum classification margins are calculated for one or more classes of the trained classifier. Overfitting is then mitigated by reducing one or more of these calculated maximum classification margins while maintaining the accuracy of the trained classifier for the clean dataset.

In some embodiments, calculating a classification margin for an input pattern comprises determining the difference between (1) a largest output logit signal of the trained classifier that corresponds to a decided-upon class of the input pattern, and (2) a second-largest output logit signal activated by the input pattern.

In some embodiments, classification accuracy of the trained classifier is preserved by including, within a mitigation objective function to be optimized, a term that preserves the class logits of the clean dataset.

In some embodiments, the mitigation of overfitting is achieved by optimizing-over bounds on neural activations in the trained classifier.

In some embodiments, calculating a maximum classification margin involves performing gradient ascent starting from different, randomly-chosen, feasible input-pattern initializations to find a set of locally-maximal classification margins for the class, and then considering the maximum from the set and/or the average of the set as the maximal classification margin.

In some embodiments, the disclosed techniques involve reducing the maximum classification margins for all classes of the trained classifier.

In some embodiments, mitigating overfitting for the trained classifier encompasses preventing backdoor poisoning of the trained classifier. For instance, the techniques may involve determining the classes whose maximum classification margins will be reduced using a backdoor detector, where the classes that are reduced are the backdoor target classes that were detected by the backdoor detector.

In some embodiments, the mitigation of overfitting for the trained classifier involves mitigating potential non-malicious sources of bias associated with, but not limited to, one or more of class imbalances in the training set, a lack of sufficient training set diversity, or over-training of the trained classifier.

In some embodiments, classification accuracy is preserved by including, within a mitigation objective function to be optimized, a cross-entropy loss term evaluated on the clean dataset.

In some embodiments, mitigation of overfitting is achieved by optimizing-over bounds on neural activations in the trained classifier.

In some embodiments, the classification margin maximization is performed using an internal layer of the neural network classifier rather than the input layer.

In some embodiments, the mitigation operation involves creating a mitigated classifier based on the trained classifier that includes the reduced maximum classification margins. During operation, a received test sample is separately evaluated using both the trained classifier and the mitigated classifier. If the class decisions of the trained classifier and the modified classifier differ for the test input sample the test input sample is determined to be a backdoor trigger. More specifically, when the decisions differ, this could indicate that the class decision made by the trained classifier is an estimated target class of the backdoor trigger and/or that an opposing class decision made by the mitigated classifier is an estimated source class of the backdoor trigger.

In some embodiments, even when the the trained classifier and the mitigated classifier agree on the class decision for a given sample, the given sample may still be detected as a backdoor trigger sample if an unusually large classification margin difference is detected for the given sample between the trained classifier and the mitigated classifier.

In some embodiments, the disclosed techniques further comprise detecting backdoor-poisoning of the trained classifier. After computing an estimate of the maximum classification margin for the classes of the trained classifier, the system may detect one or more target classes of a putative backdoor for the trained classifier when the corresponding maximum classification margins for those target classes are anomalously high compared to the maximum classification margins of other classes.

In some embodiments, the method further involves estimating a null model based on the smallest maximum classification margins determined for the classes of the trained classifier, evaluating order-statistic p-values with respect to this null model of the maximum classification margins of the remaining classes of the trained classifier, and then applying a threshold to these p-values.

### BRIEF DESCRIPTION OF THE FIGURES

FIG. 1 illustrates mitigation of malicious backdoor poisoning against a DNN classifier in accordance with an embodiment.

FIG. 2 illustrates an exemplary set of backdoor patterns for a classification problem of low-resolution images in accordance with an embodiment.

FIG. 3 illustrates an exemplary ensemble detection system involving two DNNs which are used to detect flaws in photographs of objects with radial symmetry in accordance with an embodiment.

FIG. 4A presents a flow chart that illustrates the process of mitigating overfitting for a trained classifier in accordance with an embodiment.

FIG. 4B presents a flow chart that illustrates the process of detecting backdoor poisoning of a trained classifier in accordance with an embodiment.

FIG. 5 illustrates a computing environment in accordance with an embodiment.

FIG. 6 illustrates a computing device in accordance with an embodiment.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a non-transitory computer-readable storage medium, which may be any device or non-transitory medium that can store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a non-transitory computer-readable storage medium as described above. When a computer system reads and executes the code and/or data stored on the non-transitory computer-readable storage medium, the computer system performs the methods and processes embodied as data structures and code and stored within the non-transitory computer-readable storage medium.

Furthermore, the methods and processes described below can be included in hardware modules. For example, the hardware modules can include, but are not limited to, application-specific integrated circuit (ASIC) chips, a full-custom implementation as part of an integrated circuit (or another type of hardware implementation on an integrated circuit), field-programmable gate arrays (FPGAs), a dedicated or shared processor that executes a particular software module or a piece of code at a particular time, and/or other programmable-logic devices now known or later developed. When the hardware modules are activated, the hardware modules perform the methods and processes included within the hardware modules.

### Deep Neural Networks (DNNs) and Backdoor Poisoning

Deep Neural Networks (DNNs), also known as Artificial Intelligences (AIs), have achieved state-of-the-art performance in various application domains involving large and complex datasets including: classification (e.g., of images, speech, or text), regression/prediction (e.g., denoising a signal), control (e.g., of a player in an artificial role-playing or board game, or of a complex real-world physical system), and generative modeling (e.g., video and large-language models). Note that, for simpler tasks, classification can be achieved by different machine-learned models such as support-vector machines (SVMs, in supervised fashion as for DNNs) or clustering models such as K-means, Gaussian mixture models, parsimonious mixture models, one-class SVMs, one-class DNNs, or DNN autoencoders (in unsupervised fashion). Also note that the action of, e.g., regression or control can also be interpreted as classification when a finite set of possible outputs/actions are involved or when that is achieved by output clustering or partitioning, e.g., quantization.

DNNs typically have an enormous number of parameters and a wide variety of architectures (models). Some commonly used feed-forward, multilayer architectures for the case of the imaging domain include ResNet and LeNet, which have convolutional layers (with rectangular convolutional kernels). Other architectures have “attention” layers (e.g., transformer models), while still others are customized to specific applications (e.g., to exploit radial symmetry of the objects of interest in the images). DNN parameters are learned (i.e., the DNN is trained) typically by gradient-based minimization of a loss objective over the DNN's parameters, where the loss objective is typically additive over the commensurately large training dataset. For example, gradients of a cross-entropy loss function computed by back-propagation are used to learn a multi-layer DNN classifier; and if that classifier has units/neurons with memory in order to act on dependent sequential data then “back-propagation through time” can be employed. Rectified Linear Units (ReLUs) are used to expedite the deep learning process by avoiding the small-magnitude gradients that can be caused when sigmoid-type neurons are used. Often much more costly and time-consuming than such (supervised) deep learning processes is the process through which the training dataset itself is formulated and subsequently curated. When deployed, a DNN may experience “model drift” and require parameter refinement through active learning or (online) reinforcement learning.

The formulation of the DNN architecture and the deep learning process itself are often heuristic considering the complexity of the data and the required highly “non-convex” nature of its input-output mapping. Thus, even after a long and costly deep learning process, a DNN may behave in unexpected ways when it is operationally deployed, i.e., at test time. Studies have shown how a DNN may make serious mistakes on specially crafted “adversarial” test samples (adversarial inputs), even though its behavior on the training dataset is acceptable.

Studies have also shown that trained DNNs may have hidden biases, e.g., predicting a cow is present in a scene that contains only grass because grass was predominantly present in the training set examples of scenes with cows. Such hidden biases are sometimes referred to as intrinsic backdoors or natural backdoors. That is, a natural backdoor occurs without backdoor poisoning of the training dataset. Such backdoors may be an artifact of the training set, the DNN architecture, or the deep-learning process, or they may be an intrinsic aspect of the classification problem for the given domain.

Because of its necessarily enormous size, the task of producing elements of the training dataset (or even the training process) are often outsourced or involve a large amount of manual curation (as in offline Reinforcement Learning with Human Feedback or RLHF). Thus, there is significant potential for the training dataset to be maliciously poisoned. Additionally, poisoning can occur through an online active learning or online reinforcement learning process. The objective of such data poisoning could be to generally reduce the accuracy of the DNN (i.e., error-generic data poisoning) or to plant a backdoor (i.e., a Trojan), where the latter facilitates an adversarial input (e.g., a backdoor trigger at test time). It has been frequently observed that very little poisoning is required to plant an effective backdoor (with the possible exception of “clean label” backdoor poisoning).

Consider an online active learning process that may be compromised by data poisoning. Suppose there is a pool of unlabeled samples and the objective is to decide which of them to label in order to refine the model. Suppose the attacker knows the criterion used for selecting samples to add to the training dataset, creates or collects such samples, mislabels them, and plants them into the pool so that they will be chosen by the active learner. In one embodiment, the active learner may use a single sample selection policy, e.g., selecting for labeling the sample with greatest decision uncertainty (such as the sample with highest class entropy). In another embodiment, an ensemble of sample selection criteria may be in play, for example, selecting samples i) in regions of high unlabeled-sample density or ii) in regions of low labeled-sample density. In this ensemble policy case, the active learner can compute the correlations between each sample-selection criterion's statistic with the gain in model accuracy accrued by labeling samples using that policy (and refining the model based on such samples). At each active learning “step,” the learner may choose the sample selection criterion with the largest such correlation.

For the example of a DNN classifier, backdoor poisoning may cause an input sample which belongs to one class (a source class of the backdoor attack) to instead be classified to a different class (a target class of the backdoor attack) when the backdoor pattern is incorporated into the sample. An effective backdoor attack is one where incorporation of the backdoor pattern results in only a subtle modification of the sample so as to evade detection either by automated means or by manual human inspection. Also, covert backdoor poisoning will not significantly impact the DNN's accuracy on clean data. For the case of unsupervised clustering (mapping input samples to different clusters where each cluster can consist of separate components), the attack could alter features of a clean sample to add a backdoor pattern and weaken cluster/component-representative features of the clean sample (as in “clean label” backdoor attacks on classifiers). In one embodiment of unsupervised clustering, a parsimonious mixture model could be applied to the embedded features of an DNN autoencoder.

### Limitations of Existing Approaches

Several prior works have considered the problem of unsupervised detection and mitigation of backdoor data-poisoning in DNN classifiers. Here, “unsupervised” means that the proposed solutions are not assumed to have examples of input samples that are backdoor triggers, nor to have examples of backdoor poisoned and unpoisoned DNNs (the latter as in the 2019 IARPA TrojAI supervised backdoor-detection problem), nor, of course, to possess knowledge of the backdoor pattern itself or the way it is incorporated into a sample. Moreover, several prior works have also considered the post-training problem wherein it is typically assumed that the training dataset is not available (and so is not relied upon for detection and mitigation). Note that embodiments of the present invention are both unsupervised and post-training—e.g., they do not rely on access to the training dataset and do not rely on prior knowledge of: whether or not the DNN was backdoor-poisoned, the classes involved, the backdoor pattern, or its method of incorporation. Such embodiments are effective for a wide variety of backdoor patterns and methods of backdoor pattern incorporation. That is, the disclosed techniques describe a universal backdoor detector and mitigator.

Some prior methods attempt to reverse engineer the backdoor pattern, e.g., Neural Cleanse (NC), TABOR, NAD and I-PT-RED (U.S. Pat. No. 11,514,297 B2). These reverse engineering defense (RED) methods typically rely on gradient-based neural network inversion techniques. They also typically inherently assume something about the way the backdoor pattern is incorporated, e.g., additively, blended, patch replaced. Reverse-engineering based detection methods may produce one or several different statistics for each putative target class of a putative backdoor attack. Different REDs may compute different statistics. Moreover, REDs may differ from each other in how detection is performed based on the respective statistics. Obviously, multiple such detectors can be combined to account for different methods of backdoor incorporation, but such an ensemble detector will not account for all possible ways that a backdoor pattern can be incorporated.

An embodiment of the I-PT-RED method proposed in U.S. Pat. No. 11,514,297 B2 attempts to reverse engineer the backdoor by additive perturbations applied to an embedded (internal) feature space representation of the DNN and argues that this approach may be effective even when the backdoor pattern was not additively incorporated into the raw (input) feature space representation. That is, this approach is at least somewhat agnostic to the method of backdoor pattern incorporation and the backdoor pattern. For backdoor mitigation, NC embeds the backdoor pattern reverse-engineered for the target class detected by NC into clean (undoctored and correctly classified) images from all source classes, and then, using these thus modified images, fine-tunes the parameters of the classifier deemed to be attacked to “unlearn” the backdoor mapping. Note that the disclosed techniques are not based on a reverse engineering method, and do not attempt to mitigate a detected backdoor by fine-tuning the model's parameters.

Some detection and mitigation methods require further assumptions, e.g., that the backdoor pattern is in a particular location within the sample (e.g., in a corner of an image), or involves hyperparameters which somehow need to be set. For example, given multiple exemplar DNNs with and without backdoors present, one can tune hyperparameters of a detector so as to minimize the number of missed detections and false detections over the exemplar set. However, there are several issues with such an approach. First, it is computationally exorbitant and may be computationally infeasible to train all these exemplar DNNs. Second, the DNNs without backdoors can only be trained if there is sufficient clean (unpoisoned) data available—but if this were the case, then one could simply use an unpoisoned DNN operationally, i.e., in such a case there would be no need for backdoor detection. Third, this approach is supervised, as a poisoned exemplar DNN is obtained by assuming a particular backdoor pattern and method of incorporation. Supervised detectors are often found to be ineffective at detecting backdoor types that were not included in the supervision set. Again, some embodiments of the present invention disclose an unsupervised detection and mitigation approach, relying on no knowledge of a possible backdoor pattern or its method of incorporation.

Fine-Pruning (FP) is a non-reverse-engineering based backdoor-mitigation method that requires only a (relatively small) clean dataset. The premise behind FP is that backdoor patterns will activate neurons that are not triggered by clean patterns. Thus, the defender can prune neurons in increasing order of their average activations over a clean validation set, doing so up until the point where there is an unacceptable loss in classification accuracy on the clean dataset. This may remove neurons which trigger on backdoor patterns. One limitation of pruning is that the neural network should be large enough. Otherwise, for a compact enough network, the neurons triggering on backdoor patterns would also trigger on some clean patterns so that any pruning would necessarily result in a loss in classification accuracy. Moreover, FP does not detect the presence of backdoor attacks—neurons are pruned even for an unattacked (unpoisoned) classifier. A crucial hypothesis in FP is that if a backdoor has been encoded in a DNN, there will exist “backdoor” neurons with significant weights to the next layer (or to the decision layer), but which are never (or rarely) activated, except by backdoor patterns. This hypothesis is similar to that of Patent WO 2014/137416A1 for the problem of detecting and identifying portions of generic hardware (not necessarily a neural network) that correspond to a backdoor. This hypothesis implicitly assumes that somehow, during the DNN training/optimization, extra (otherwise unused (inactive)) neurons, e.g., in the penultimate layer of the network, are being suborned solely to fulfill the backdoor mapping, with the rest of the network largely unaffected, during training, by the backdoor training patterns. However, there is nothing about (gradient-based) DNN training that is likely to ensure this surgical “compartmentalization” of the learned DNN, with some neurons that are exclusively used to achieve the backdoor mapping. Thus, it is asserted that FP is not effective as a general method for post-training mitigation of backdoors in DNNs. Unlike FP (which is a mitigation method based on activations), Trojan Signatures (TS) detects whether a backdoor has been planted into the model based on the weight parameters of the layers near the output of the model. Both TS and FP attempt to be backdoor agnostic and the TS article (Fields et al. ICCV'21) notes that activations of the backdoor pattern in a backdoor-trigger input sample need to exceed those of its source-class discriminative features.

One can use a small clean dataset to (post-training) fine-tune the parameters of a potentially-backdoor-attacked DNN, e.g., applying gradient-based learning for some iterations using a cross-entropy loss objective based on the small clean dataset to adjust the DNN's parameters, in the hopes of removing the backdoor while preserving overall accuracy. For example, under Neural Attention Distillation (NAD), a teacher is first obtained by fine-tuning the possibly attacked DNN's (student model's) parameters on a small clean dataset. A large learning rate (gradient-descent step-size) is used in an attempt to remove the backdoor from the teacher model, but significant reduction in the overall accuracy of the teacher model may result. The student model is fine-tuned under the guidance of the teacher model's activations in an attempt to both remove the backdoor and preserve accuracy.

Note that the disclosed embodiments of the present invention do not involve fine-tuning the parameters of the potentially backdoor-attacked DNN in the manner of the gradient-based deep-learning process used to train it based on, e.g., a cross-entropy loss training objective. Moreover, embodiments of the present invention do not modify the parameters learned through the deep-learning process at all.

Alternatively, one could hypothesize that insertion of a backdoor may cause a significant increase in class entropy or, even more specifically, in the “confusion” between the backdoor source and target classes. However, detection based on such ideas should only be possible if the backdoor is not well designed: a successful backdoor attack is such that the network learns the backdoor mapping and, at the same time, induces essentially no extra error rate on clean (backdoor-free) test samples. Thus, if the attack is successful, one should not expect the class-decision entropy or class confusion between two classes (measured on a clean test set) to be significantly increased.

### A Universal Backdoor Detector and Mitigator

Some embodiments of the present invention detect DNNs which are backdoor attacked based on the influence of a backdoor attack on the classifier's logit functions f, independent of the backdoor pattern and its method of incorporation. The DNN's class decision for input x is given by argmax_{k∈Y} fₖ(x), i.e., the class with largest logit activated by input x, where Y is the set of classes. For a backdoor attacked DNN classifier with associated target class t, it is hypothesized that

$$\\ {max}_{\underline{x} ∈ {}_{} 𝒰} [ {f}_{t} ( \underline{x} ) - {max}_{k ∈ {}_{} 𝒴 {}_{} \backslash {}_{} t} {f}_{k} ( \underline{x} ) ] ≫ {max}_{\underline{x} ∈ {}_{} 𝒰} [ {f}_{i} ( \underline{x} ) - {max}_{{k}^{{}_{} ′} ∈ {}_{} 𝒴 {}_{} \backslash {}_{} i} {f}_{{k}^{{}_{} ′}} ( \underline{x} ) ] , ∀ i ∈ 𝒴 \backslash t .$$

Here U is the input space of the DNN. That is, it is hypothesized that the maximum classification margin (MM) statistic for the true backdoor-attack target class (t) will be much larger than the MM statistics for all other classes. This hypothesis is motivated by observations that the activations caused by the backdoor pattern need to overcome those induced by the characteristic source class (the class from which the sample originates) features in order for the DNN to decide to the attacker's target class, t.

In some embodiments of the present invention, for each class i∈Y, with every class a possible target class of an attack, the maximum classification margin (the right-hand-side of the previous display) is first estimated by gradient ascent starting from a random initial x (note that no clean class-i samples are used for such optimization). For a feed-forward DNN, the gradients can be obtained via back-propagation with respect to the DNN's input variables, as in neural network inversion. Denote the estimated maximum margin statistic for each class i as rᵢ and the largest statistic as rₘₐₓ=maxᵢ rᵢ. In some embodiments, a null distribution H (e.g., a Gamma cumulative distribution function) is estimated using all statistics excluding rₘₐₓ. The order statistic p-value is given by pv=1−(H(rₘₐₓ))^{K-1}. That is, pv is the probability that one of K−1 independent chosen samples from the null distribution will exceed rₘₐₓ, where K=|Y| is the number of classes. Detection with estimated confidence (1−θ)×100% (e.g., θ=0.05 for 95% confidence) is achieved when pv<θ.

A number of variations build upon the above-disclosed techniques. For example, there may be multiple backdoor attacks, in which case more than one of the largest statistics r (not just the largest) will be outliers. That is, a group of the n≥1 largest statistics r could be held out from the estimation of the null model H, and a modified order-statistic p-value (with exponent K−n>0 instead of K−1) could be computed for each of them for purpose of detecting whether the DNN is backdoor attacked and which target classes are involved. Here, K−n needs to be large enough to form an accurate null model. In another embodiment, Median Absolute Deviation (MAD) is used instead of order-statistic p-values.

The input space of the DNN could be discrete, so in some embodiments a discrete optimization strategy, e.g., simulated annealing, genetic algorithms, or grid search, is used to find the maximum classification margin for each class. Alternatively, the discrete space can be relaxed or embedded into a continuum (in particular, allowing for gradient-based optimization of the objective below, while periodically “projecting” the intermediate states reached during optimization to feasible values in the original discrete space). In another embodiment, classification margin maximization is performed using an internal layer of the DNN, rather than the input layer.

Note that this detection method neither relies on a particular backdoor pattern nor the method of its incorporation into source-class samples. That is, the disclosed techniques employ a backdoor-agnostic (universal) method of detecting whether a DNN classifier is backdoor poisoned. The following other elements of the disclosed techniques share this property.

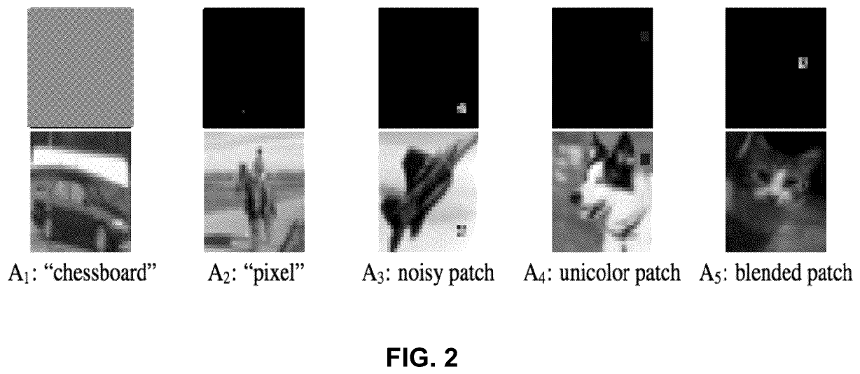

FIG. 2 illustrates examples of different ways a backdoor pattern can be incorporated into an input sample for an image classification domain. More specifically, in FIG. 2 these examples are illustrated for a classification problem of low-resolution images, with different backdoor patterns and methods of incorporation illustrated for each case.

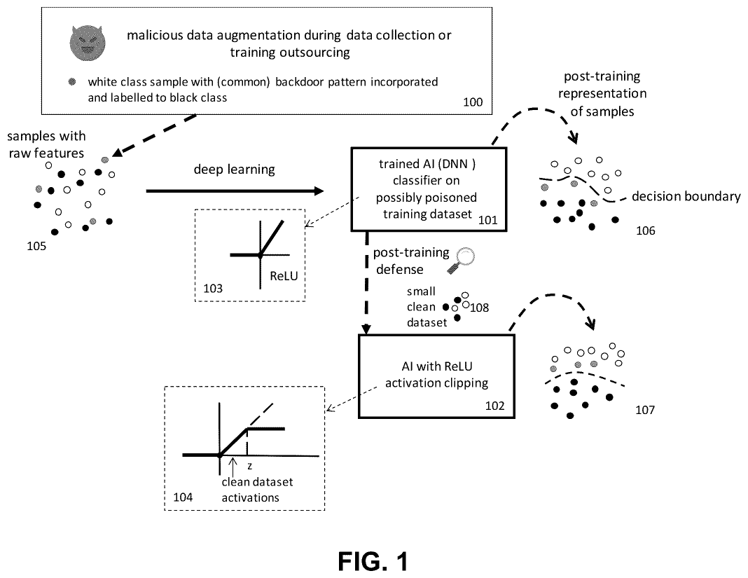

FIG. 1 illustrates an exemplary embodiment of the present invention for mitigation of malicious backdoor poisoning against a DNN classifier (to white & black classes). The adversary 100 plants poisoned grey samples into the training dataset 105. These grey samples are (source) white-class samples with the common backdoor pattern incorporated in them and labelled to the (target) black class. The thus poisoned DNN 101 incorrectly classifies such grey samples (both training and test samples) as belonging to the black class even though these samples “look like” they belong to the white class (106). In one embodiment of the present invention, some or all of the Rectified Linear Unit (ReLU) activations 103 of the DNN 101 are clipped (bounded or limited) (104) to produce the DNN 102 which correctly classifies the grey backdoor triggers as belonging to the white class (107), i.e., mitigating the backdoor. To this end, the clipping of these neural activation functions depends on the availability of some clean (backdoor-free and correctly classified) samples from each of the classes (108).

Some embodiments of the present invention also post-training mitigate backdoor poisoning, as illustrated in FIG. 1 and summarized above. In some embodiments of the present invention, neural activations are bounded (limited, clipped, saturated) in order to prevent large activations due to overfitting to the backdoor pattern while, at the same time, not impacting the classification accuracy on a set of labeled samples D which are clean (i.e., known to be correctly classified and not backdoor triggers), where D is in general very small compared to the training dataset of the DNN. As such, these aspects of the disclosed techniques follow a basic security principle of limiting the functionality of a system to prevent activity which is extraneous to the designed behavior of a system (here, the “normal” range of activations induced on the clean set, D). In particular, the activations of Rectified Linear Units (ReLU), having activations of the form, e.g., h(u)=max{0, u}, can be bounded at z>0 to produce an activation of the form g(u; z)=min{h(u), z}. Note that (unbounded) ReLUs allow for large gradients, which can expedite the deep learning process, but which also enables overfitting to backdoor patterns; this motivates post-training activation clipping of ReLUs to mitigate (undo learning of) backdoor mappings. In one embodiment, this clipping occurs after the DNN has been (post-training) detected as backdoor poisoned. In another embodiment, this clipping is performed independent of any prior backdoor detection (with the goal to mitigate a possible planted backdoor but also not to degrade classification accuracy in the absence of a planted backdoor). Different bounds z for different ReLUs in the DNN are determined based on the activations on a small clean dataset D (of unpoisoned and correctly classified samples) with representatives from all the different classes. In some embodiments, the ReLU clipping thresholds Z are found by minimizing the following objective:

$$\\ {\sum }_{\underline{x} ∈ {}_{} 𝒟} {\sum }_{k ∈ {}_{} 𝒴} {[ {g}_{k} ( \underline{x} ; Z ) - {f}_{k} ( \underline{x} ) ]}^{2} + {λ}_{1} {\sum }_{ℓ ∈ {}_{} Λ} {‖ {\underline{z}}_{{}_{} ℓ} ‖}_{2} + {λ}_{2} {max}_{{\underline{x}}^{{}_{} ′} ∈ {}_{} 𝒰 , {}_{} t ∈ {}_{} 𝒴} [ {g}_{t} ( {\underline{x}}^{{}_{} ′} ; Z ) - {max}_{k \neq {}_{} t} {}_{} {g}_{k} ( {\underline{x}}^{{}_{} ′} ; Z ) ]$$

Here gₖ is the logit for class k when activation clipping is applied, using the vector of clipping levels (with, in general, one for each RELU neuron in the DNN), Z. Also, f are the logits of the original DNN, U is the space of (whole) input patterns of the DNN, A is the set of layers of the DNN, z is a vector of bounds used on the RELUs in a given layer from Λ (the vectors z are subvectors of Z), and the hyperparameters λ>0. The first term of this objective aims to preserve the logits on the clean dataset D (under the assumption that backdoor poisoning does not significantly alter logits on clean samples—only those containing significant features of the backdoor pattern). The second term aims to explicitly limit the maximum possible outputs (activations) produced by (clipped) ReLUs. The final term aims to minimize the (estimated) maximum margin on the class with largest maximum margin, t. Again, if backdoor detection was first applied, with a target class k identified, then a variant of the above objective would be minimized, one which penalizes the maximum margin of the detected target class, k, not simply the class with largest maximum margin.

Some embodiments include one or more variations for the foregoing backdoor-mitigation method. For example, the term minimizing the norms on the saturation bounds may be absent (λ₁=0), i.e., minimizing the maximum margin may be all that is necessary to suppress the backdoor, for a wide variety of backdoor attacks. In the case where detection is first applied, there may be more than one detected target class, so in some embodiments the third term may comprise a sum or average over the multiple target classes. In another embodiment, the final term of the above objective may instead be the average over all classes of the average of locally maximum classification margins for each class (this embodiment does not rely on a previously applied detection method). In some embodiments, each locally-maximum classification margin is computed by gradient ascent starting from a random initial point. In other embodiments, only some of the ReLUs are clipped.

In some embodiments, the maximum classification margin is obtained by optimizing over an embedded (rather than input) feature space, h. In this embodiment activation clipping would occur between layer h and the output of the DNN. During optimization it can be periodically checked whether an embedded feature representation y can be achieved by a feasible input x. In some embodiments, this is done by minimizing ∥h(x)−y∥² over the input x and continuing the maximization process with h([x]) instead of y, where [x] is the feasible input nearest to x.

In some embodiments, other types of neural activations (non-ReLU, e.g., neural activations which are piecewise-linear but completely unbounded, i.e., unrectified, or completely bounded (e.g., sigmoid)) are considered while preserving accuracy on the clean dataset D. In some embodiments, the above objective can be minimized to find both upper and lower bounds on neural activations. In some embodiments, certain types of neural network parameters (e.g., those of batch-normalization layers) can also or instead be modified or bounded toward reducing the maximum classification margin while preserving accuracy on a clean dataset D.

Note that in before-training or during-training (deep learning) scenarios, where the possibly poisoned training dataset is available, the DNN model can be (deeply) learned using the dataset, and then the disclosed techniques can be applied prior to deployment of the DNN. Thus, embodiments of the present invention may obviate the need for techniques that try to cleanse the training dataset but which may not be fully agnostic to the backdoor pattern type.

Embodiments of the present invention can also be used to identify the backdoor-poisoned samples in the training dataset or operational/test-time backdoor triggers based on their classification margins. In one embodiment, both the original and modified (backdoor-mitigated) DNNs are operationally deployed and an input sample is detected as a backdoor trigger when the two class decisions disagree on this sample. More specifically, the associated target class for the attack would be that decided by the original DNN and the (corrected) source class would be that identified by the backdoor-mitigated DNN. As mentioned above, this approach can be applied to one or both of test-time (operational) samples and to training set samples (in a non-post-training scenario).

In some embodiments, a backdoor trigger is detected when the difference in the classification margin between the original and modified DNNs (respectively 101 and 102 of FIG. 1) is sufficiently high, even when their class decisions are the same (i.e., to address false negatives). In unsupervised fashion, the threshold for detection can be set to limit the false-positive rate on the small clean dataset D in one embodiment. In another embodiment, the clean samples D can be used to form a null density of the difference in classification margin between the two DNNs, and the p-value of the difference in classification margins of a test sample can be computed from the null; if the p-value is less than, e.g., 0.05 for a Gaussian null then the test sample is deemed a backdoor trigger with 95% confidence.

In some embodiments, the disclosed techniques can be used in combination with other detection and mitigation methods, e.g., as part of an ensemble detector (e.g., with I-PT-RED applied to embedded features), or when performing mitigation in combination with a method that refines the DNN model parameters (e.g., I-BAU). In some embodiments, a detector attempts to reverse engineer the backdoor pattern, for arbitrary methods of incorporating that pattern. Consider again the small clean dataset D and its subset D(s) from a putative source class s of a putative backdoor attack. Let δₓ be a sample-specific, additive, putative-backdoor perturbation of a sample x∈D(s) and let h be the mapping from the input of the DNN to one of its internal layers, i.e., h(x) is an embedded feature representation of x (h(x) is a vector of neural activations of an internal layer when the input is x). A backdoor may generally manifest as a common additive perturbation μ in the embedded representation. In one embodiment, for each putative source-target class pair (s,t), the sample specific perturbations δ are initialized (arbitrarily but so that x+δₓ is feasible for all x∈D(s)) and then iteratively the following two steps are repeatedly computed until convergence:

$$\\ \begin{matrix}μ = {\vert D ( s ) \vert}^{- 1} {\sum }_{x ∈ D ( s )} ( h ( x + {δ}_{x} ) - h ( x ) ) . & 1 )\end{matrix}$$

$$\\ \begin{matrix}for all x ∈ D ( s ) , {δ}_{x} = arg {min}_{δ} [ {‖ h ( x + δ ) - ( h ( x ) + μ ) ‖}^{2} - λ {f}_{t} ( x + δ ) ] & 2 )\end{matrix}$$

where λ>0 and fₜ is the class-t logit function of the DNN. In some embodiments, a backdoor is detected if the mean associated perturbation magnitudes |D(s)|⁻¹ Σ_{x∈D(s)} ∥δₓ∥ are abnormally small for a particular putative source-target class pair (s,t) (compared to other class pairs), and/or if ∥μ∥ is abnormally large when the corresponding embedded feature space (network layer h) is close to the DNN's output (overfitting to the backdoor pattern (i.e., with unusually large maximum margins) may imply that perturbation magnitudes in embedded feature spaces close to the output layer are unusually large). In some embodiments, abnormality can be estimated using median absolute deviation (MAD) or the detection method of I-PT-RED based on order-statistic p-values. Again, note that is interpreted as the activation due to a putative backdoor pattern with source class s and target class t, and so when taken at a layer h closer to the DNN's output, may cause classification to the target class when it has high magnitude, ∥μ∥. When taken at a layer closer to the input, ∥μ∥ may be abnormally small when there is a backdoor, which is consistent with I-PT-RED. In some embodiments, this foregoing iterative, two-step method is performed just for each putative target class using all non-target class clean samples U_{s≠t} D(s). In some embodiments, h is not an embedded feature-vector of the DNN but another feature map which is anticipated to be similar to one of them (e.g., word2vec in text processing); this is useful when the internal activations of the defended DNN are not available to the defender. In some embodiments, to promote convergence, the positive parameter λ is dynamically modified during the iterative optimization process to compute and the sample-specific perturbations δ.

In some embodiments of the present invention, the difference in classification margin between the original and otherwise modified DNN (e.g., modified by a refinement approach like I-BAU) can be used to detect backdoor triggers when the decisions by the two DNNs agree (and a backdoor trigger is also detected when their decisions disagree).

The backdoor detection method of the present invention can also be used to detect natural (or intrinsic) backdoors, to which the DNN may also overfit. Recall that such natural backdoors may indicate biases in the training dataset or the deep learning process. If upon inspection these backdoor patterns are undesirable artifacts of the classifier, the backdoor mitigation method of the present invention can be used to address them. Moreover, adding a maximum-classification margin term over the training dataset to a cross-entropy loss objective may help to reduce bias/overfitting during the training process.

In some embodiments, the first term of the above minimization objective could be replaced by a cross-entropy loss term (e.g., a term commonly used as an objective to train a classifier) over the clean dataset D. Rather than mitigating backdoor poisoning, the objective of activation clipping could now be to mitigate non-malicious overfitting bias due to class imbalance in the training dataset, due to insufficient diversity in the training set, or due to overtraining.

The disclosed backdoor detection and mitigation techniques can also be used to address error-generic data-poisoning attacks. For example, in label-flipping attacks, the class label of some training samples is changed from the correct (source) class to a different (target) class. The deep learning process will attempt to identify features in the poisoned samples to associate with the target class of the label-flipping attack. Such features will also need to be overfit to the target class to overcome the source-class characteristic features of the label-flipped samples.

The backdoor mitigation and detection techniques of the present invention can also be applied to DNNs which produce continuous-valued outputs as, e.g., for regression or prediction. The output space can be partitioned (e.g., quantized) and each partition element deemed a class.

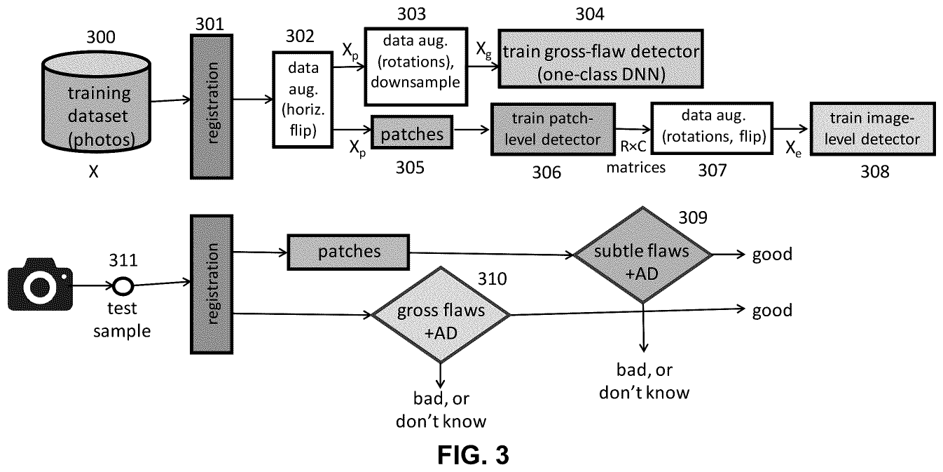

Note that a DNN classifier may have a variety of different architectures. Moreover, classification may be performed by an ensemble of different classifiers. Consider the example illustrated in FIG. 3 for smart manufacturing where the purpose is quality control by image analysis of a discrete manufactured product with radial symmetry (another problem of smart manufacturing is preventative maintenance by, e.g., predicting flaws in the machines used as part of the manufacturing process). FIG. 3 illustrates an exemplary ensemble detection system involving two DNNs which are used to detect flaws in photographs of objects with radial symmetry. To learn the DNNs, training samples (300) are registered (301) so that the object centers are in the center of the image (this may involve cropping the image). Some of the training images are without flaws, while others have different classes of flaws which are either subtle (e.g., small & localized) or gross. The (now registered) training images may be augmented (302) for example by horizontally flipping some or all of them to create additional training samples. To train the gross flaw detector (304), additional training samples may be created (303) by rotating the images and downscaling their resolution (the latter to simplify the gross-flaw detector). An example gross-flaw detector (304,310) is a one-class DNN, specifically a Convolutional Neural Network (CNN), or the Discriminator of a Generative Adversarial Network (GAN). The subtle-flaw detector (309) consists of a tandem of a patch-level detector (306) and an image-level detector (308). Image patches (305) are extracted from the augmented training samples (302) by rotating them by C different angular amounts about, and at R different radial distances from, the image center and applying a mask. Patches are labelled as clean or containing subtle flaws and then used to train a patch level detector, e.g., CNN. In some embodiments, the patch level detector outputs a “probability” of a flaw for each input patch. So, an R×C matrix of such probabilities is produced for each training image. Such matrices can also be augmented (307), e.g., by swapping rows or rotating the column positions, to produce a training dataset for the image-level detector (308) which is another deep neural network. In some embodiments, a plurality of classes of flaws are detected. At test time (online) the learned gross and subtle flaw detectors operate in parallel to detect flaws in a test sample (311): if either detects a flaw, then the test sample is deemed flawed. Note that the process of registration and extraction of radial-patches, which is employed during training, also needs to be employed at test-time. Each flaw detector could be operated with an anomaly detector (AD, 309 and 310), which is customized to it. The AD tries to detect whether the test sample is an outlier with respect to the detector's training dataset. Such test samples could be used to refine the flaw detectors, or they may be adversarial inputs, including backdoor triggers. Detection of an anomaly would result in a “don't know” response. Note that the aforementioned R×C matrix is an embedded (internal-layer) feature representation of the operational subtle-flaw detector (309) which is a tandem of the patch-level (306) and image-level (308) detectors.

In some embodiments, one can form an ensemble with a: one-class SVM, one-class DNN, or GAN Discriminator to detect gross flaws; direct measurement for particular flaws; and a custom architecture (exploiting radial symmetry) for one or more classes of subtle flaws. The learning of a “patch-level” detector of subtle flaws is based on a training dataset Xₚ, where equal-sized patches are extracted at different radial and angular positions of the product images (note that this can be done by rotating the image by different angles while keeping the patch-mask at a fixed location). Image-level detection of subtle flaws is based on augmented outputs of the patch-level flaw detector (augmented “embedded” features) represented as a matrix which can be rotated and “radially flipped” to produce the Xₑ dataset. The Xₑ dataset is then used to train a backend classifier to decide whether the (whole) image has a subtle flaw. To produce the X_{g} dataset for gross-flaw detection, bad images are rotated n degrees at a time and good images are rotated m degrees at a time. So, for each good and bad image, such augmentation will thus respectively add about 360/n bad images and 360/m good images where n and m could be chosen to balance the overall number of good and bad images in the training dataset (Alternatively, or in addition, the training loss objective could differentially weight its contributions from different training samples for this purpose). The present backdoor detection and mitigation techniques could be used on the multiclass gross-flaw and/or subtle-flaw detectors.

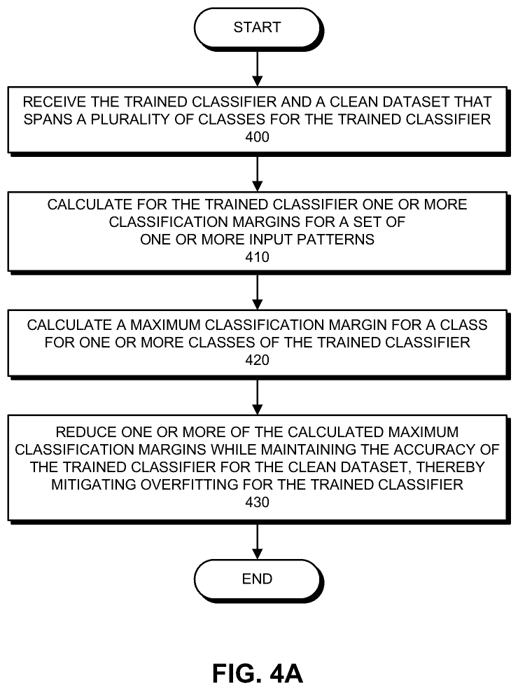

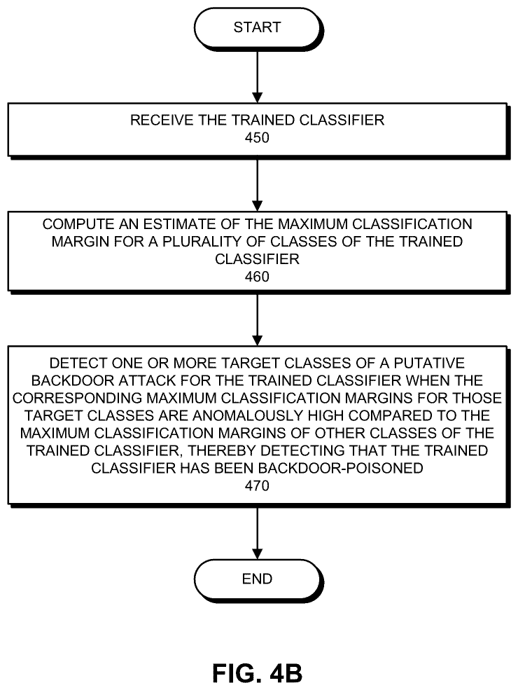

FIG. 4A presents a flow chart that illustrates the process of mitigating overfitting for a trained classifier. Mitigation of overfitting for a trained classifier begins with receiving the trained classifier and a clean dataset that spans a plurality of classes for the trained classifier (operation 400). A set of input patterns are used to calculate classification margins for the trained classifier (operation 410), and maximum classification margins are calculated for one or more classes of the trained classifier (operation 420). Overfitting is then mitigated for the trained classifier by reducing one or more of these calculated maximum classification margins while maintaining the accuracy of the trained classifier for the clean dataset (operation 430).

FIG. 4B presents a flow chart that illustrates the process of detecting backdoor poisoning of a trained classifier. During operation, a backdoor detector receives the trained classifier (operation 450) and computes an estimate of the maximum classification margins for a plurality of classes of the trained classifier (operation 460). The backdoor detector detects one or more target classes for a putative backdoor attack for the trained classifier when the corresponding maximum classification margins for those target classes are anomalously high compared to the maximum classification margins of other classes (operation 470), thereby detecting that the trained classifier has been backdoor-poisoned.

### Computing Environment

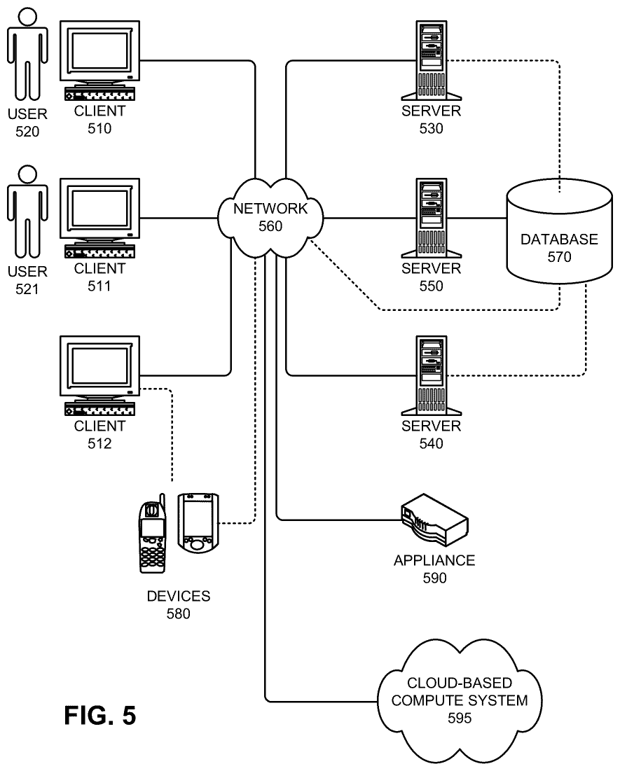

In summary, embodiments of the present invention facilitate detecting and mitigating overfitting in trained classifiers. In some embodiments of the present invention, techniques for detecting and mitigating overfitting can be incorporated into a wide range of computing devices in a computing environment. For example, FIG. 5 illustrates a computing environment 500 in accordance with an embodiment of the present invention. Computing environment 500 includes a number of computer systems, which can generally include any type of computer system based on a microprocessor, a mainframe computer, a digital signal processor, a portable computing device, a personal organizer, a device controller, or a computational engine within an appliance. More specifically, referring to FIG. 5, computing environment 500 includes clients 510-512, users 520 and 521, servers 530-550, network 560, database 570, devices 580, appliance 590, and cloud based storage system 595.

Clients 510-512 can include any node on a network that includes computational capability and includes a mechanism for communicating across the network. Additionally, clients 510-512 may comprise a tier in an n-tier application architecture, wherein clients 510-512 perform as servers (servicing requests from lower tiers or users), and wherein clients 510-512 perform as clients (forwarding the requests to a higher tier).

Similarly, servers 530-550 can generally include any node on a network including a mechanism for servicing requests from a client for computational and/or data storage resources. Servers 530-550 can participate in an advanced computing cluster, or can act as stand-alone servers. For instance, computing environment 500 can include a large number of compute nodes that are organized into a computing cluster and/or server farm. In one embodiment of the present invention, server 540 is an online “hot spare” of server 550.

Users 520 and 521 can include: an individual; a group of individuals; an organization; a group of organizations; a computing system; a group of computing systems; or any other entity that can interact with computing environment 500.

Network 560 can include any type of wired or wireless communication channel capable of coupling together computing nodes. This includes, but is not limited to, a local area network, a wide area network, or a combination of networks. In one embodiment of the present invention, network 560 includes the Internet. In some embodiments of the present invention, network 560 includes phone and cellular phone networks.

Database 570 can include any type of system for storing data related to detecting and mitigating overfitting in non-volatile storage. This includes, but is not limited to, systems based upon magnetic, optical, or magneto-optical storage devices, as well as storage devices based on flash memory and/or battery-backed up memory. Note that database 570 can be coupled: to a server (such as server 550), to a client, or directly to a network. Alternatively, other entities in computing environment 500 (e.g., servers 530-550) may also store such data.

Devices 580 can include any type of electronic device that can be coupled to a client, such as client 512. This includes, but is not limited to, cell phones, personal digital assistants (PDAs), smartphones, personal music players (such as MP3 players), gaming systems, digital cameras, portable storage media, or any other device that can be coupled to the client. Note that, in some embodiments of the present invention, devices 580 can be coupled directly to network 560 and can function in the same manner as clients 510-512.

Appliance 590 can include any type of appliance that can be coupled to network 560. This includes, but is not limited to, routers, switches, load balancers, network accelerators, and specialty processors. Appliance 590 may act as a gateway, a proxy, or a translator between server 540 and network 560.

Cloud-based compute system 595 can include any type of networked computing devices (e.g., a federation of homogeneous or heterogeneous storage devices) that together provide computing and data storage capabilities to one or more servers and/or clients. Note that the present invention is highly parallelizable. Thus, the present invention can take advantage of platforms such as Spark and Kubernetes which facilitate parallel computation in the cloud.

Note that different embodiments of the present invention may use different system configurations, and are not limited to the system configuration illustrated in computing environment 500. In general, any device that includes computational and storage capabilities may incorporate elements of the present invention.

In some embodiments of the present invention, some or all aspects of the disclosed detection and mitigation operations can be implemented as dedicated hardware modules (indeed, the neural network classifier itself may also have a customized hardware implementation.) A hardware system embodiment of the present invention might be motivated by the need to inspect a large number of possibly overfitted and/or backdoor-attacked DNN classifiers, each with a large decision space (number of classes). Such hardware modules can include, but are not limited to, processor chips, application-specific integrated circuit (ASIC) chips, field-programmable gate arrays (FPGAs), memory chips, and other programmable-logic devices now known or later developed.

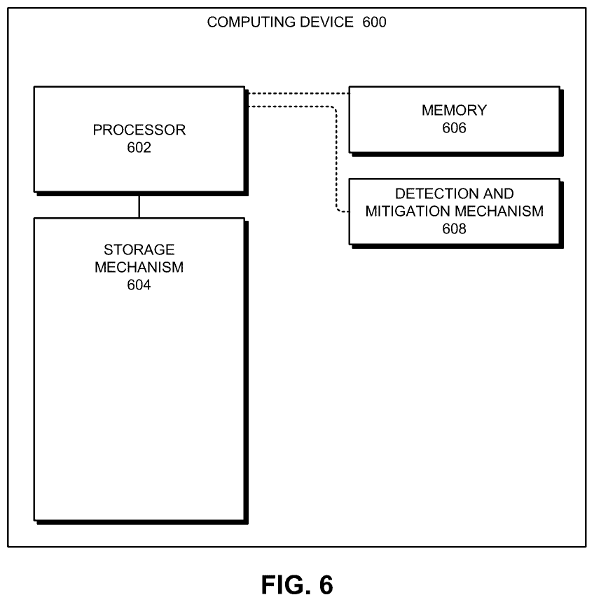

FIG. 6 illustrates a computing device 600 that includes a processor 602 and a storage mechanism 604. Computing device 600 also includes a memory 606 and a detection and mitigation mechanism 608.

In some embodiments, computing device 600 uses processor 602, memory 606, detection and mitigation mechanism 608, and storage mechanism 604 to perform functions that facilitate detecting and mitigating overfitting in classifiers. For instance, computing device 600 can execute backdoor-detection scans and/or mitigation reductions on processor 602 that inspect, analyze, and mitigate a trained classifier using data samples that are stored in one or more of memory 606, storage mechanism 604 and detection and mitigation mechanism 608 to. Program instructions executing on processor 602 can verify whether the trained classifier is clean and/or suffers from overfitting, or, if needed, determine reductions that can reduce overfitting that maintains the accuracy of the trained classifier for a known clean dataset. Note that in many embodiments, processor 602 supports executing multiple different lightweight services in a single VM using docker containers.

In some embodiments of the present invention, some or all aspects of memory 606, detection and mitigation mechanism 608, and/or storage mechanism 604 can be implemented as dedicated hardware modules in computing device 600. These hardware modules can include, but are not limited to, processor chips, application-specific integrated circuit (ASIC) chips, field-programmable gate arrays (FPGAs), memory chips, and other programmable-logic devices now known or later developed.

Processor 602 can include one or more specialized circuits for performing the operations of the mechanisms. Alternatively, some or all of the operations of memory 606, detection and mitigation mechanism 608, and/or storage mechanism 604 may be performed using general purpose circuits in processor 602 that are configured using processor instructions. Thus, while FIG. 6 illustrates detection and mitigation mechanism 608, memory 606, and/or storage mechanism 604 as being external to processor 602, in alternative embodiments some or all of these mechanisms can be internal to processor 602.

In these embodiments, when the external hardware modules are activated, the hardware modules perform the methods and processes included within the hardware modules. For example, in some embodiments of the present invention, the hardware module includes one or more dedicated circuits for performing the operations described above. As another example, in some embodiments of the present invention, the hardware module is a general-purpose computational circuit (e.g., a microprocessor or an ASIC), and when the hardware module is activated, the hardware module executes program code (e.g., BIOS, firmware, etc.) that configures the general-purpose circuits to perform the operations described above.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

### REFERENCES

G. Fields, M. Samragh, M. Javaheripi, F. Koushanfar, T. Javidi. Trojan Signatures in DDN Weights. In Proc. ICCV, 2021.
F. Huszar, P. Berkes, and Z. Wang. Active Learning System. US Patent No. US 2018/024031 A1, Aug. 23, 2018. Y. Li, X. Lyu, N. Koren, L. Lyu, B. Li and X. Ma. Neural Attention Distillation: Erasing Backdoor Triggers from Deep Neural Networks. In Proc. ICLR, 2021.
K. Liu, B. Doan-Gavitt, and S. Garg. Fine-Pruning: Defending Against Backdoor Attacks on Deep Neural Networks. In Proc. RAID, 2018.
D. J. Miller and G. Kesidis. Post-Training Detection and Identification of Human-Imperceptible Backdoor-Poisoning Attacks. U.S. Pat. No. 11,514,297 B2, issued Nov. 29, 2022.
D. J. Miller and G. Kesidis. Prioritized Detection and Classification of Clusters of Anomalous Samples on High-dimensional Continuous and Mixed Discrete/Continuous Feature Spaces. U.S. Pat. No. 10,846,308, Jul. 26, 2017.
L. Sethumadhavan, A. Waksman, and M. Suozzo. Identification of backdoors and backdoor triggers. Patent WO 2014/137416 A1, 2014.
B. Wang, Y. Yao, S. Shan, H. Li, B. Viswanath, H. Zheng, and B. Y. Zhao. Neural Cleanse: Identifying and mitigating backdoor attacks in neural networks. In Proc. IEEE Symposium on Security and Privacy, 2019.
H. Wang, Z. Xiang, D. J. Miller and G. Kesidis. Improved Activation Clipping for Universal Backdoor Mitigation and Test-Time Detection. https://arxiv.org/abs/2308.04617, 2023.
H. Wang, D. J. Miller, G. Kesidis. Post-Training Overfitting Mitigation in DNN Classifiers. https://arxiv.org/abs/2309.16827, September 2023.
Y. Zeng, S. Chen, W. Park, Z. M. Mao, M. Jin and R. Jia. Adversarial Unlearning of Backdoors via Implicit Hypergradient. In Proc. ICLR, 2022.

What is claimed is:

1. A computer-implemented method for testing for overfitting bias for a trained neural network, the method comprising:
receiving the trained neural network;
receiving a clean dataset of input samples and their correct responses;
for two or more input samples of the clean dataset, perturbing their activations at a first layer of the trained neural network to both (i) achieve a common perturbation at a second layer of the trained neural network located between the first layer and the output of the trained neural network, and (ii) change the output of the trained neural network to a possible target response; and
testing for overfitting bias for the possible target response based on at least one of (i) the perturbations of the first layer, (ii) the perturbations at the second layer, and (iii) the output logits.

2. The computer-implemented method of claim 1, wherein testing for overfitting bias further comprises measuring for possible target responses at least one of: the largeness of the average perturbation at the second layer; the smallness of the variance of the perturbations at the second layer; the average smallness of the perturbations at the first layer; and the largeness of the average decision margin.

3. The computer-implemented method of claim 2, wherein testing for overfitting bias further comprises determining with statistical significance that a measurement associated with the possible target response is anomalous compared to those of one or more other possible target responses and hence that the trained neural network has overfitting bias to the anomalous target response.

4. The computer-implemented method of claim 3, wherein statistical significance for an anomalous measurement comprises two standard deviations beyond at least one of the mean or median across two or more possible target responses.

5. The computer-implemented method of claim 2, wherein testing for overfitting bias further comprises determining with statistical significance that no measurements associated with any of the possible target responses of the trained neural network are anomalous and hence deciding that the trained neural network does not have overfitting bias.

6. The computer-implemented method of claim 1, wherein:
the trained neural network is a classifier;
the target responses are classes; and
a classification margin is determined by output class logits.

7. The computer-implemented method of claim 1, wherein the first layer is the input layer of the trained neural network.

8. The computer-implemented method of claim 1, wherein testing for overfitting bias further comprises determining a frequency with which a given perturbation at the first layer that causes an input sample from the clean dataset to produce the possible target response also causes other clean inputs from the clean dataset to also produce the possible target response.

9. The computer-implemented method of claim 1, wherein overfitting bias indicates a backdoor data-poisoning attack.

10. The computer-implemented method of claim 1, wherein:
the trained neural network is a transformer;
the target responses are token sequences; and
the first layer is a token-embedding layer in the trained neural network that precedes a first attention layer.

11. A computer-implemented method for testing for overfitting bias for a trained neural network, the method comprising:
receiving the trained neural network;
defining a detection criterion for possible responses of the trained neural network based on the trained neural network's output logits;
calculating a maximum for the detection criterion over a set of inputs to the trained neural network for two or more of the trained neural network's output logits; and
testing for overfitting bias to a corresponding output logit based on the calculated maximum detection criteria.

12. The computer-implemented method of claim 11, wherein detecting overfitting bias further involves determining with statistical significance that the maximum detection criterion associated with a specific output logit is anomalous compared to those of one or more other output logits.

13. The computer-implemented method of claim 12, wherein statistical significance comprises at least two standard deviations beyond at least one of the mean or median of the maximum detection criteria across at least two output logits.

14. The computer-implemented method of claim 11, wherein
the trained neural network is a classifier;
each output logit corresponds to a different class; and
each detection criterion is a class logit.

15. The computer-implemented method of claim 11, wherein
the trained neural network is a classifier;
each output logit corresponds to a different class; and
each detection criterion is a classification margin.

16. The computer-implemented method of claim 11, wherein calculating a maximum detection criterion involves gradient ascent with respect to the activations of a layer of the trained neural network.

17. The computer-implemented method of claim 11, wherein overfitting bias indicates a backdoor data-poisoning attack.

18. The computer-implemented method of claim 11, wherein:
the trained neural network is a transformer;
different logits correspond to different output tokens; and
calculating a maximum detection criterion involves using gradient ascent with respect to the token-embedding activations of the input.

19. A non-transitory computer-readable storage medium storing instructions that when executed by a computer cause the computer to perform a method for testing for overfitting bias for a trained neural network, the method comprising:
receiving the trained neural network;
defining a detection criterion for possible responses of the trained neural network based on the trained neural network's output logits;
calculating a maximum for the detection criterion over a set of inputs to the trained neural network for two or more of the trained neural network's output logits; and
testing for overfitting bias to a corresponding output logit based on the calculated maximum detection criteria.

20. A testing system that tests for overfitting bias for a trained neural network, comprising:
a processor;
a memory; and
a detection mechanism;
wherein at least one of the processor and the detection mechanism are configured to receive the trained neural network and store the program instructions associated with the trained neural network in the memory;
wherein the testing system is configured to:
define a detection criterion for possible responses of the trained neural network based on the trained neural network's output logits;
calculate a maximum for the detection criterion over a set of inputs to the trained neural network for two or more of the trained neural network's output logits; and
test for overfitting bias to a corresponding output logit based on the calculated maximum detection criteria.
